(19) United States
(12) Patent Application Publication
(10) Pub. No.: US 2023/0059731 A1
(43) Pub. Date: Feb. 23, 2023

(54) DYNAMICALLY ENABLING AND DISABLING PHYSICAL DOWNLINK SHARED CHANNEL SCHEDULING USING DOWNLINK CONTROL INFORMATION

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 17/793,452

(22) PCT Filed: Jan. 23, 2020
(86) PCT No.: PCT/CN2020/074008

§ 371 Date: Jul. 18, 2022

(51) Int. Cl. H04W 72/12; H04L 1/18

(52) U.S. Cl. CPC H04W 72/1273; H04W 72/1289; H04L 1/1812

(57) ABSTRACT

Aspects of the disclosure relate to a method of wireless communication. An exemplary method includes formatting a first downlink control information (DCI) to schedule a first plurality of physical downlink shared channels (PDSCHs) in a first plurality of cells and transmitting the first DCI in a first physical downlink control channel (PDCCH) to a scheduled entity. Another method includes identifying a search space in a resource element grid within which a control region set (CORESET) is located, decoding the CORESET to obtain a first downlink control information (DCI), determining, from the first DCI, locations in the resource element grid that contain a first plurality of physical downlink shared channels (PDSCHs) in a first plurality of cells scheduled for use of the scheduled entity, and decoding data located in the first plurality of PDSCHs. Other aspects and features are also claimed and described.

### TECHNICAL FIELD

The technology discussed below relates generally to wireless communication systems, and more particularly, to dynamically enabling and disabling physical downlink shared channel (PDSCH) scheduling using downlink control information (DCI).

### INTRODUCTION

As the demand for mobile broadband access continues to increase, research and development continue to advance wireless communication technologies not only to meet the growing demand for mobile broadband access, but to advance and enhance the user experience with mobile communications.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one example a method of wireless communication, operational at a scheduling entity, is disclosed. The method includes formatting a first downlink control information (DCI) to schedule a first plurality of physical downlink shared channels (PDSCHs) in a first plurality of cells and transmitting the first DCI in a first physical downlink control channel (PDCCH) to a scheduled entity. According to one aspect, an apparatus for wireless communication is disclosed. The apparatus includes means for formatting a first downlink control information (DCI) to schedule a first plurality of physical downlink shared channels (PDSCHs) in a first plurality of cells and means for transmitting the first DCI in a first physical downlink control channel (PDCCH) to a scheduled entity. According to one example, a non-transitory computer-readable medium storing computer-executable code is disclosed. According to one example, the code causes the computer to format a first downlink control information (DCI) to schedule a first plurality of physical downlink shared channels (PDSCHs) in a first plurality of cells and transmit the first DCI in a first physical downlink control channel (PDCCH) to a scheduled entity. According to another aspect, an apparatus for wireless communication includes a processor, a transceiver communicatively coupled to the processor, and a memory communicatively coupled to the processor. In one example, the processor is configured to format a first downlink control information (DCI) to schedule a first plurality of physical downlink shared channels (PDSCHs) in a first plurality of cells and transmit the first DCI in a first physical downlink control channel (PDCCH) to a scheduled entity.

In another example, a method of wireless communication, operational at a scheduled entity is disclosed. According to one aspect, the method includes identifying a search space in a resource element grid within which a control region set (CORESET) is located, decoding the CORESET to obtain a first downlink control information (DCI), determining, from the first DCI, locations in the resource element grid that contain a first plurality of physical downlink shared channels (PDSCHs) in a first plurality of cells scheduled for use of the scheduled entity, and decoding data located in the first plurality of PDSCHs. According to one aspect, an apparatus for wireless communication includes means for identifying a search space in a resource element grid within which a control region set (CORESET) is located, means for decoding the CORESET to obtain a first downlink control information (DCI), means for determining, from the first DCI, locations in the resource element grid that contain a first plurality of physical downlink shared channels (PDSCHs) in a first plurality of cells scheduled for use of the scheduled entity, and means for decoding data located in the first plurality of PDSCHs. In one example a non-transitory computer-readable medium storing computer-executable code id disclosed. According to one aspect, the code causes the computer to identify a search space in a resource element grid within which a control region set (CORESET) is located, decode the CORESET to obtain a first downlink control information (DCI), determine, from the first DCI, locations in the resource element grid that contain a first plurality of physical downlink shared channels (PDSCHs) in a first plurality of cells scheduled for use of the scheduled entity, and decode data located in the first plurality of PDSCHs. In still another example, an apparatus for wireless communication is disclosed that includes a processor, a transceiver communicatively coupled to the processor, and a memory communicatively coupled to the processor. In one example, the processor is configured to identify a search space in a resource element grid within which a control region set (CORESET) is located, decode the CORESET to obtain a first downlink control information (DCI), determine, from the first DCI, locations in the resource element grid that contain a first plurality of physical downlink shared channels (PDSCHs) in a first plurality of cells scheduled for use of the scheduled entity, and decode data located in the first plurality of PDSCHs.

These and other aspects of the invention will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a block diagram illustrating a wireless communication system supporting multiple-input multiple-output (MIMO) communication.

FIG. 4 is a schematic illustration of an organization of wireless resources in an air interface utilizing orthogonal frequency divisional multiplexing (OFDM) according to some aspects.

FIG. 5 is a schematic illustration of an OFDM air interface utilizing a scalable numerology according to some aspects of the disclosure.

FIG. 6 is a block diagram conceptually illustrating an example of a hardware implementation for a scheduling entity employing a processing system according to some aspects of the disclosure.

FIG. 7 is a block diagram conceptually illustrating an example of a hardware implementation for a scheduled entity employing a processing system according to some aspects of the disclosure.

FIG. 8A is a call flow diagram depicting an exchange of messages between a scheduling entity and a scheduled entity and a scheduling of a plurality of physical downlink shared channels (PDSCHs) on a plurality of cells (e.g., carriers, component carriers) according to some aspects of the disclosure.

FIG. 8B graphically depicts one aspect of the transmission scheduling and retransmission scheme that may be implemented in networks that are adapted to use a single DCI to schedule the plurality of PDSCHs on the plurality of cells according to some aspects of the disclosure.

FIG. 8C also graphically depicts the one aspect of the transmission scheduling and retransmission scheme that may be implemented in networks that are adapted to use a single DCI to schedule the plurality of PDSCHs on the plurality of cells according to some aspects of the disclosure.

FIG. 9 is a block diagram illustrating a scheduling of physical downlink shared channels (PDSCHs) and retransmission of PDCCHs that were associated with negative acknowledgements (NACKs) according to some aspects of the disclosure.

FIG. 10 is a call flow diagram depicting an exchange of messages between a scheduling entity and a scheduled entity and a truth table for determining conditions under which scheduled downlink channels are retransmitted according to some aspects of the disclosure.

FIG. 11 is a flow chart illustrating an exemplary process for wireless communication operational at a scheduling entity in accordance with some aspects of the present disclosure.

FIG. 12 is a flow chart illustrating an exemplary process for wireless communication operational at a scheduling entity in according to some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

Various aspects described herein may relate to dynamic spectrum sharing (DSS) and the use of a single downlink control information (DCI) signal to schedule PDSCH or PUSCH on multiple cells (e.g., multiple component carriers). Aspects described herein may additionally or alternatively relate to transmission scheme selection when capable of multiple PDSCHs scheduled by the same DCI. For example, a carrier indicator field (CIF) in a DCI may be configured to corresponds to a given cell or set of cells (e.g., CIF corresponds to {Cell A}, {Cell B}, {Cell A and Cell B}). A greater number of cells is within the scope of the disclosure. For instance, if CIF=Cell A, the DCI may schedule a single PDSCH on Cell A. Additionally if the new data indicator (NDI) in the DCI is not toggled, the DCI may reschedule a PDSCH of the same HARQ ID previously transmitted on cell A. In another instance, if CIF=Cell B, the DCI may schedule a single PDSCH on Cell B. Additionally, if the NDI in the DCI is not toggled, the DCI may reschedule a PDSCH of the same HARQ ID previously transmitted on cell B. In still another instance, if CIF=Cell A and B, the DCI may schedule individual PDSCHs on Cell A and Cell B. Additionally, if the NDI in the DCI is not toggled, the DCI may reschedule a PDSCH of the same HARQ ID previously transmitted on cell A and B.

According to another aspect, search space (e.g., frequency and time domain spatial search) sharing may be implemented. By way of example, a same Coreset or search space and a set of control channel elements (CCEs) may be configured to DCIs with CIF={cell A}, {cell B}, and {cell A, B}. In one aspect, at most one DCI may be indicated with CIF={cell A}, {cell B}, and {cell A, B} per PDCCH occasion per cell. By way of example, using E-UTRA for exemplary and non-limiting purposes, a CCE may be a group of resources which can be used to send a PDCCH. CCEs may be grouped (e.g., one, two, four, or eight CCEs) to support larger messages. Again, for exemplary purposes only, one CCE may consists of nine resource element groups (REGs).

According to another aspect, if a downlink assignment index (DAI) counter (C-DAI) is increased by 1 per DCI, and at most one DCI can be indicated with CIF={cell A}, {cell B}, and {cell A, B} per PDCCH occasion per cell, the number of ACK/NACK bits in a PUCCH for the cell may be based on multiple PDSCH scheduling. A value of the counter downlink assignment indicator (C-DAI) field in a DCI denotes the accumulative number of {serving cell, PDCCH monitoring occasion}-pair(s) in which PDSCH reception(s) or SPS PDSCH release is present, up to the current serving cell and current PDCCH monitoring occasion. The value of the total DAI (T-DAI), when present, in a DCI denotes the total number of {serving cell, PDCCH monitoring occasion}-pair(s) in which PDSCH reception(s) or SPS PDSCH release is present, up to the current PDCCH monitoring occasion and is updated from PDCCH monitoring occasion to the PDCCH monitoring occasion. As understood by those of skill in the art, the DAI is an index, which is communicated to a UE by gNB (or eNB, or access node) to prevent ACK/NACK reporting errors due to HARQ ACK/NACK bundling procedure performed by the UE.

According to still another aspect, ACK/NAK bundling may be applied to multiple PDSCHs scheduled by the same DCI. For example, one ACK/NAK bit may be generated to multiple PDSCHs scheduled by the same DCI, per code block group (CBG) or per transport block (TB). The following features may be implemented
ACK/NACK=1 if all the PDSCHs are decoded correctly,
A/N=0 if any of the PDSCHs is decoded incorrectly, and
the access node (e.g., gNB, eNB) reschedule all of the PDSCHs of the same CBG or TB by the same DCI if ACK/NACK=0 (that is, if any of the PDSCHs are decoded incorrectly).

### Definitions

RAT: radio access technology. The type of technology or communication standard utilized for radio access and communication over a wireless air interface. Just a few examples of RATs include GSM, UTRA, E-UTRA (LTE), Bluetooth, and Wi-Fi.

NR: new radio. Generally refers to 5G technologies and the new radio access technology undergoing definition and standardization by 3GPP in Release 15.

Legacy compatibility: may refer to the capability of a 5G network to provide connectivity to pre-5G devices, and the capability of 5G devices to obtain connectivity to a pre-5G network.

Multimode device: a device that can provide simultaneous connectivity across different networks, such as 5G, 4G, and Wi-Fi networks.

CA: carrier aggregation. 5G networks may provide for aggregation of sub-6 GHz carriers, above-6 GHz carriers, mmWave carriers, etc., all controlled by a single integrated MAC layer.

MR-AN: multi-RAT radio access network. A single radio access network may provide one or more cells for each of a plurality of RATs, and may support inter- and intra-RAT mobility and aggregation.

MR-CN: multi-RAT core network. A single, common core network may support multiple RATs (e.g., 5G, LTE, and WLAN). In some examples, a single 5G control plane may support the user planes of a plurality of RATs by utilizing software-defined networking (SDN) technology in the core network.

SDN: software-defined networking. A dynamic, adaptable network architecture that may be managed by way of abstraction of various lower-level functions of a network, enabling the control of network functions to be directly programmable.

SDR: software-defined radio. A dynamic, adaptable radio architecture where many signal processing components of a radio such as amplifiers, modulators, demodulators, etc. are replaced by software functions. SDR enables a single radio device to communicate utilizing different and diverse waveforms and RATs simply by reprogramming the device.

mmWave: millimeter-wave. Generally refers to high bands above 24 GHz, which can provide a very large bandwidth.

Beamforming: directional signal transmission or reception. For a beamformed transmission, the amplitude and phase of each antenna in an array of antennas may be precoded, or controlled to create a desired (e.g., directional) pattern of constructive and destructive interference in the wavefront.

MIMO: multiple-input multiple-output. MIMO is a multi-antenna technology that exploits multipath signal propagation so that the information-carrying capacity of a wireless link can be multiplied by using multiple antennas at the transmitter and receiver to send multiple simultaneous streams. At the multi-antenna transmitter, a suitable precoding algorithm (scaling the respective streams' amplitude and phase) is applied (in some examples, based on known channel state information). At the multi-antenna receiver, the different spatial signatures of the respective streams (and, in some examples, known channel state information) can enable the separation of these streams from one another.
1. In single-user MIMO, the transmitter sends one or more streams to the same receiver, taking advantage of capacity gains associated with using multiple Tx, Rx antennas in rich scattering environments where channel variations can be tracked.
2. The receiver may track these channel variations and provide corresponding feedback to the transmitter. This feedback may include channel quality information (CQI), the number of preferred data streams (e.g., rate control, a rank indicator (RI)), and a precoding matrix index (PMI).

Massive MIMO: a MIMO system with a very large number of antennas (e.g., greater than an 8×8 array).

MU-MIMO: a multi-antenna technology where base station, in communication with a large number of UEs, can exploit multipath signal propagation to increase overall network capacity by increasing throughput and spectral efficiency, and reducing the required transmission energy.
1. The transmitter may attempt to increase the capacity by transmitting to multiple users using its multiple transmit antennas at the same time, and also using the same allocated time-frequency resources. The receiver may transmit feedback including a quantized version of the channel so that the transmitter can schedule the receivers with good channel separation. The transmitted data is precoded to maximize throughput for users and minimize inter-user interference.

AS: access stratum. A functional grouping consisting of the parts in the radio access network and in the UE, and the protocols between these parts being specific to the access technique (i.e., the way the specific physical media between the UE and the radio access network is used to carry information).

NAS: non-access stratum. Protocols between UE and the core network that are not terminated in the radio access network.

RAB: radio access bearer. The service that the access stratum provides to the non-access stratum for transfer of user information between a UE and the core network.

Network slicing: a wireless communication network may be separated into a plurality of virtual service networks (VSNs), or network slices, which are separately configured to better suit the needs of different types of services. Some wireless communication networks may be separated, e.g., according to eMBB, IoT, and URLLC services.

eMBB: enhanced mobile broadband. Generally, eMBB refers to the continued progression of improvements to existing broadband wireless communication technologies such as LTE. eMBB provides for (generally continuous) increases in data rates and increased network capacity.

IoT: the Internet of things. In general, this refers to the convergence of numerous technologies with diverse use cases into a single, common infrastructure. Most discussions of the IoT focus on machine-type communication (MTC) devices.

URLLC: ultra-reliable and low-latency communication. Sometimes equivalently called mission-critical communication. Reliability refers to the probability of success of transmitting a given number of bytes within 1 ms under a given channel quality. Ultra-reliable refers to a high target reliability, e.g., a packet success rate greater than 99.999%. Latency refers to the time it takes to successfully deliver an application layer packet or message. Low-latency refers to a low target latency, e.g., 1 ms or even 0.5 ms (for comparison, a target for eMBB may be 4 ms).

MTC: machine-type communication. A form of data communication that involves one or more entities that do not necessarily need human interaction. Optimization of MTC services differs from that for human-to-human communications because MTC services generally involve different market scenarios, data communications, lower costs and effort, a potentially very large number of communicating terminals, and, to a large extent, little traffic per terminal. (See 3GPP TS 22.368.)

Duplex: a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and interference cancellation techniques. Full duplex emulation is frequently implemented for wireless links by utilizing frequency division duplex (FDD) or time division duplex (TDD). In FDD, the transmitter and receiver at each endpoint operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction.

OFDM: orthogonal frequency division multiplexing. An air interface may be defined according to a two-dimensional grid of resource elements, defined by separation of resources in frequency by defining a set of closely spaced frequency tones or sub-carriers, and separation in time by defining a sequence of symbols having a given duration. By setting the spacing between the tones based on the symbol rate, inter-symbol interference can be eliminated. OFDM channels provide for high data rates by allocating a data stream in a parallel manner across multiple subcarriers.

CP: cyclic prefix. A multipath environment degrades the orthogonality between subcarriers because symbols received from reflected or delayed paths may overlap into the following symbol. A CP addresses this problem by copying the tail of each symbol and pasting it onto the front of the OFDM symbol. In this way, any multipath components from a previous symbol fall within the effective guard time at the start of each symbol, and can be discarded.

Scalable numerology: in OFDM, to maintain orthogonality of the subcarriers or tones, the subcarrier spacing is equal to the inverse of the symbol period. A scalable numerology refers to the capability of the network to select different subcarrier spacings, and accordingly, with each spacing, to select the corresponding symbol period. The symbol period should be short enough that the channel does not significantly vary over each period, in order to preserve orthogonality and limit inter-subcarrier interference.

RSMA: resource spread multiple access. A non-orthogonal multiple access scheme generally characterized by small, grantless data bursts in the uplink where signaling over head is a key issue, e.g., for IoT.

LBT: listen before talk. A non-scheduled, contention-based multiple access technology where a device monitors or senses a carrier to determine if it is available before transmitting over the carrier. Some LBT technologies utilize signaling such as a request to send (RTS) and a clear to send (CTS) to reserve the channel for a given duration of time.

D2D: device-to-device. Also point-to-point (P2P). D2D enables discovery of, and communication with nearby devices using a direct link between the devices (i.e., without passing through a base station, relay, or other node). D2D can enable mesh networks, and device-to-network relay functionality. Some examples of D2D technology include Bluetooth pairing, Wi-Fi Direct, Miracast, and LTE-D.

IAB: integrated access and backhaul. Some base stations may be configured as IAB nodes, where the wireless spectrum may be used both for access links (i.e., wireless links with UEs), and for backhaul links. This scheme is sometimes referred to as wireless self-backhauling. By using wireless self-backhauling, rather than requiring each new base station deployment to be outfitted with its own hard-wired backhaul connection, the wireless spectrum utilized for communication between the base station and UE may be leveraged for backhaul communication, enabling fast and easy deployment of highly dense small cell networks.

QoS: quality of service. The collective effect of service performances which determine the degree of satisfaction of a user of a service. QoS is characterized by the combined aspects of performance factors applicable to all services, such as: service operability performance; service accessibility performance; service retainability performance; service integrity performance; and other factors specific to each service.

Blockchain: a distributed database and transaction processing technology having certain features that provide secure and reliable records of transactions in a way this is very resistant to fraud or other attacks. When a transaction takes place, many copies of a transaction record are sent to other participants in a network, each of which simultaneously confirms the transaction via a mathematical calculation. Blocks are accepted via a scoring algorithm based on these confirmations. A block is a group or batch of transaction records, including a timestamp and a hash of a previous block, linking the blocks to one another. This string of blocks forms a blockchain. In a wireless communication network, especially one with large numbers of IoT devices, a blockchain can improve security and trust to the ability for any type of transaction or instructions between devices.

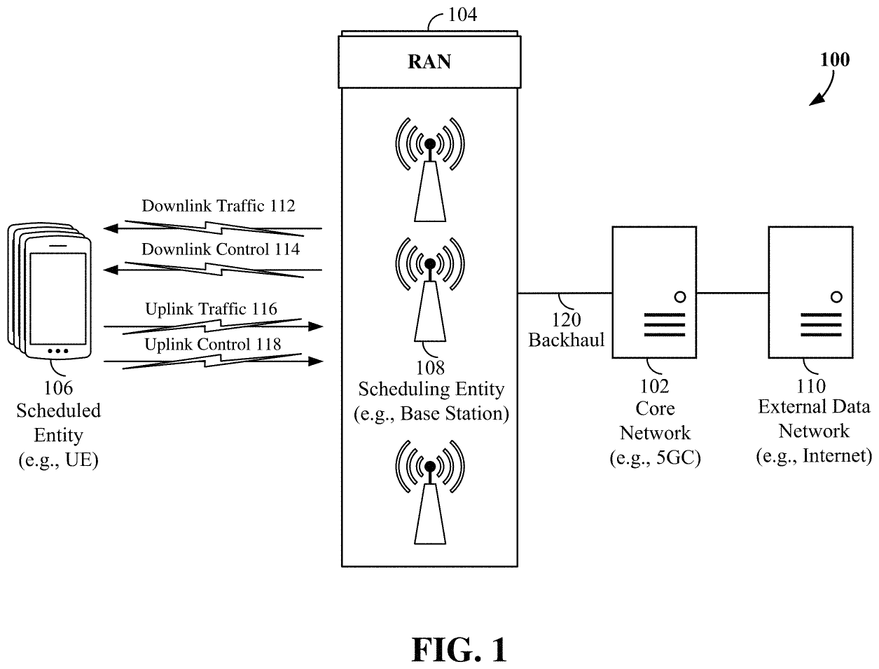

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

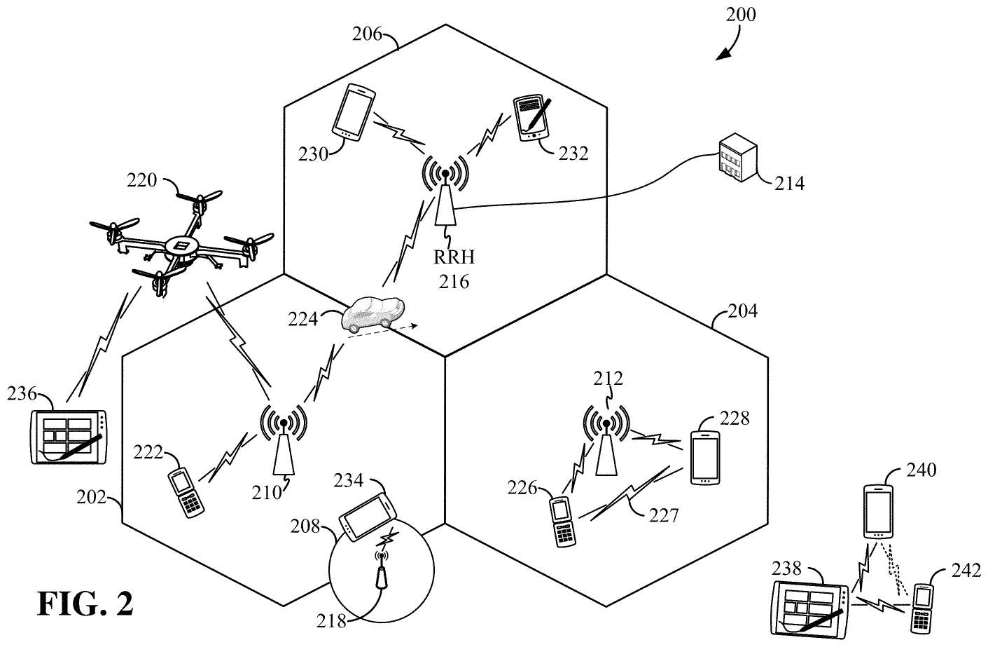

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH by feeder cables. In the illustrated example, the cells 202, 204, and 126 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

In the radio access network 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

In various aspects of the disclosure, a radio access network 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the radio access network 200. Each of the cells may measure a strength of the pilot signal, and the radio access network (e.g., one or more of the base stations 210 and 214/216 and/or a central node within the core network) may determine a serving cell for the UE 224. As the UE 224 moves through the radio access network 200, the network may continue to monitor the uplink pilot signal transmitted by the UE 224. When the signal strength or quality of the pilot signal measured by a neighboring cell exceeds that of the signal strength or quality measured by the serving cell, the network 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The air interface in the radio access network 200 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

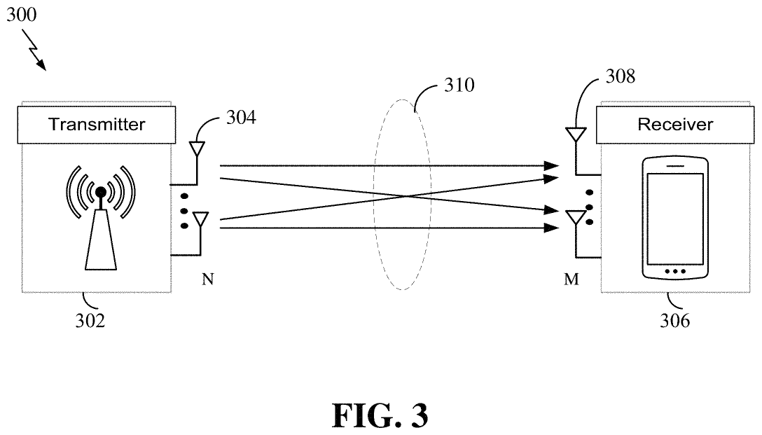

In some aspects of the disclosure, the scheduling entity and/or scheduled entity may be configured for beamforming and/or multiple-input multiple-output (MIMO) technology. FIG. 3 illustrates an example of a wireless communication system 300 supporting MIMO. In a MIMO system, a transmitter 302 includes multiple transmit antennas 304 (e.g., N transmit antennas) and a receiver 306 includes multiple receive antennas 308 (e.g., M receive antennas). Thus, there are N x M signal paths 310 from the transmit antennas 304 to the receive antennas 308. Each of the transmitter 302 and the receiver 306 may be implemented, for example, within a scheduling entity 108, a scheduled entity 106, or any other suitable wireless communication device.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the MIMO system 300 is limited by the number of transmit or receive antennas 304 or 308, whichever is lower. In addition, the channel conditions at the UE, as well as other considerations, such as the available resources at the base station, may also affect the transmission rank. For example, the rank (and therefore, the number of data streams) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

In Time Division Duplex (TDD) systems, the UL and DL are reciprocal, in that each uses different time slots of the same frequency bandwidth. Therefore, in TDD systems, the base station may assign the rank for DL MIMO transmissions based on UL SINR measurements (e.g., based on a Sounding Reference Signal (SRS) transmitted from the UE or other pilot signal). Based on the assigned rank, the base station may then transmit the CSI-RS with separate C-RS sequences for each layer to provide for multi-layer channel estimation. From the CSI-RS, the UE may measure the channel quality across layers and resource blocks and feed back the CQI and RI values to the base station for use in updating the rank and assigning REs for future downlink transmissions.

In the simplest case, as shown in FIG. 3, a rank-2 spatial multiplexing transmission on a 2×2 MIMO antenna configuration will transmit one data stream from each transmit antenna 304. Each data stream reaches each receive antenna 308 along a different signal path 310. The receiver 306 may then reconstruct the data streams using the received signals from each receive antenna 308.

In order for transmissions over the radio access network 200 to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

However, those of ordinary skill in the art will understand that aspects of the present disclosure may be implemented utilizing any suitable channel code. Various implementations of scheduling entities 108 and scheduled entities 106 may include suitable hardware and capabilities (e.g., an encoder, a decoder, and/or a CODEC) to utilize one or more of these channel codes for wireless communication.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

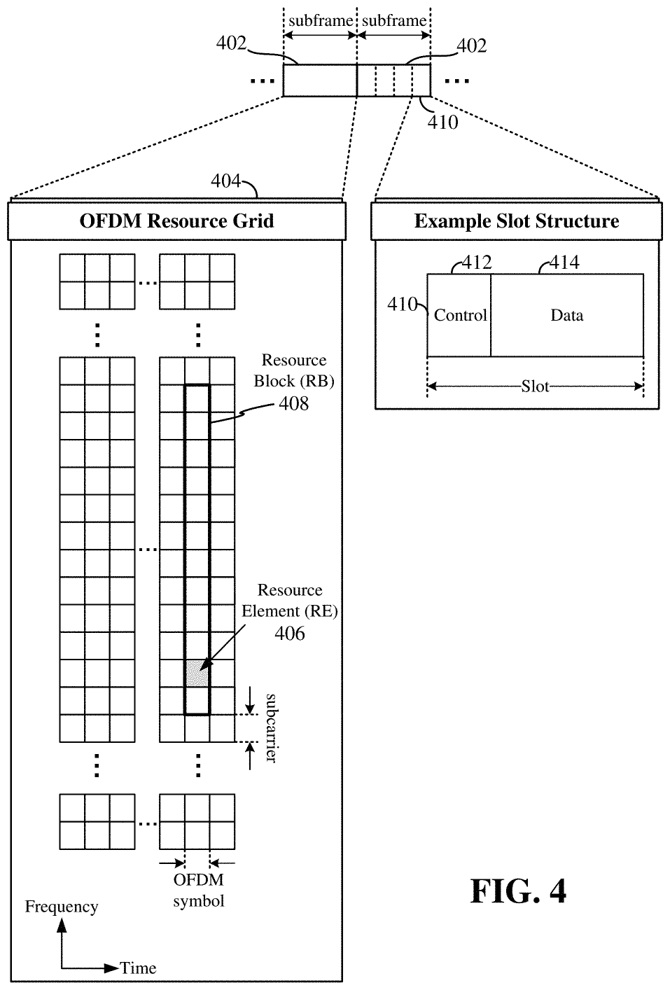

Various aspects of the present disclosure will be described with reference to an OFDM waveform, schematically illustrated in FIG. 4. It should be understood by those of ordinary skill in the art that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

Within the present disclosure, a frame refers to a duration of 10 ms for wireless transmissions, with each frame consisting of 10 subframes of 1 ms each. On a given carrier, there may be one set of frames in the UL, and another set of frames in the DL. Referring now to FIG. 4, an expanded view of an exemplary DL subframe 402 is illustrated, showing an OFDM resource grid 404. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers or tones.

The resource grid 404 may be used to schematically represent time-frequency resources for a given antenna port. That is, in a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A UE generally utilizes only a subset of the resource grid 404. An RB may be the smallest unit of resources that can be allocated to a UE. Thus, the more RBs scheduled for a UE, and the higher the modulation scheme chosen for the air interface, the higher the data rate for the UE.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each subframe 402 (e.g., a 1 ms subframe) may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., 1, 2, 4, or 7 OFDM symbols). These mini-slots may in some cases be transmitted occupying resources scheduled for ongoing slot transmissions for the same or for different UEs.

An expanded view of one of the slots 410 illustrates the slot 410 including a control region 412 and a data region 414. In general, the control region 412 may carry control channels (e.g., PDCCH), and the data region 414 may carry data channels (e.g., PDSCH or PUSCH). Of course, a slot may contain all DL, all UL, or at least one DL portion and at least one UL portion. The simple structure illustrated in FIG. 4 is merely exemplary in nature, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In a DL transmission, the transmitting device (e.g., the scheduling entity 108) may allocate one or more REs 406 (e.g., within a control region 412) to carry DL control information 114 including one or more DL control channels that generally carry information originating from higher layers, such as a physical broadcast channel (PBCH), a physical downlink control channel (PDCCH), etc., to one or more scheduled entities 106. In addition, DL REs may be allocated to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

The synchronization signals PSS and SSS (collectively referred to as SS), and in some examples, the PBCH, may be transmitted in an SS block that includes 4 consecutive OFDM symbols, numbered via a time index in increasing order from 0 to 3. In the frequency domain, the SS block may extend over 240 contiguous subcarriers, with the subcarriers being numbered via a frequency index in increasing order from 0 to 239. Of course, the present disclosure is not limited to this specific SS block configuration. Other nonlimiting examples may utilize greater or fewer than two synchronization signals; may include one or more supplemental channels in addition to the PBCH; may omit a PBCH; and/or may utilize nonconsecutive symbols for an SS block, within the scope of the present disclosure.

The PDCCH may carry downlink control information (DCI) for one or more UEs in a cell. This can include, but is not limited to, power control commands, scheduling information, a grant, and/or an assignment of REs for DL and UL transmissions.

In an UL transmission, a transmitting device (e.g., a scheduled entity 106) may utilize one or more REs 406 to carry UL control information 118 (UCI). The UCI can originate from higher layers via one or more UL control channels, such as a physical uplink control channel (PUCCH), a physical random access channel (PRACH), etc., to the scheduling entity 108. Further, UL REs may carry UL physical signals that generally do not carry information originating from higher layers, such as demodulation reference signals (DM-RS), phase-tracking reference signals (PT-RS), sounding reference signals (SRS), etc. In some examples, the control information 118 may include a scheduling request (SR), i.e., a request for the scheduling entity 108 to schedule uplink transmissions. Here, in response to the SR transmitted on the control channel 118, the scheduling entity 108 may transmit downlink control information 114 that may schedule resources for uplink packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission confirmed, an ACK may be transmitted, whereas if not confirmed, a NACK may be transmitted. In response to a NACK, the transmitting device may send a HARQ retransmission, which may implement chase combining, incremental redundancy, etc.

In addition to control information, one or more REs 406 (e.g., within the data region 414) may be allocated for user data or traffic data. Such traffic may be carried on one or more traffic channels, such as, for a DL transmission, a physical downlink shared channel (PDSCH); or for an UL transmission, a physical uplink shared channel (PUSCH).

In order for a UE to gain initial access to a cell, the RAN may provide system information (SI) characterizing the cell. This system information may be provided utilizing minimum system information (MSI), and other system information (OSI). The MSI may be periodically broadcast over the cell to provide the most basic information required for initial cell access, and for acquiring any OSI that may be broadcast periodically or sent on-demand In some examples, the MSI may be provided over two different downlink channels. For example, the PBCH may carry a master information block (MIB), and the PDSCH may carry a system information block type 1 (SIB1). In the art, SIB1 may be referred to as the remaining minimum system information (RMSI).

OSI may include any SI that is not broadcast in the MSI. In some examples, the PDSCH may carry a plurality of SIBs, not limited to SIB1, discussed above. Here, the OSI may be provided in these SIBs, e.g., SIB2 and above.

The channels or carriers described above and illustrated in FIGS. 1 and 4 are not necessarily all the channels or carriers that may be utilized between a scheduling entity 108 and scheduled entities 106, and those of ordinary skill in the art will recognize that other channels or carriers may be utilized in addition to those illustrated, such as other traffic, control, and feedback channels.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

In OFDM, to maintain orthogonality of the subcarriers or tones, the subcarrier spacing may be equal to the inverse of the symbol period. A numerology of an OFDM waveform refers to its particular subcarrier spacing and cyclic prefix (CP) overhead. A scalable numerology refers to the capability of the network to select different subcarrier spacings, and accordingly, with each spacing, to select the corresponding symbol duration, including the CP length. With a scalable numerology, a nominal subcarrier spacing (SCS) may be scaled upward or downward by integer multiples. In this manner, regardless of CP overhead and the selected SCS, symbol boundaries may be aligned at certain common multiples of symbols (e.g., aligned at the boundaries of each 1 ms subframe). The range of SCS may include any suitable SCS. For example, a scalable numerology may support a SCS ranging from 15 kHz to 480 kHz.

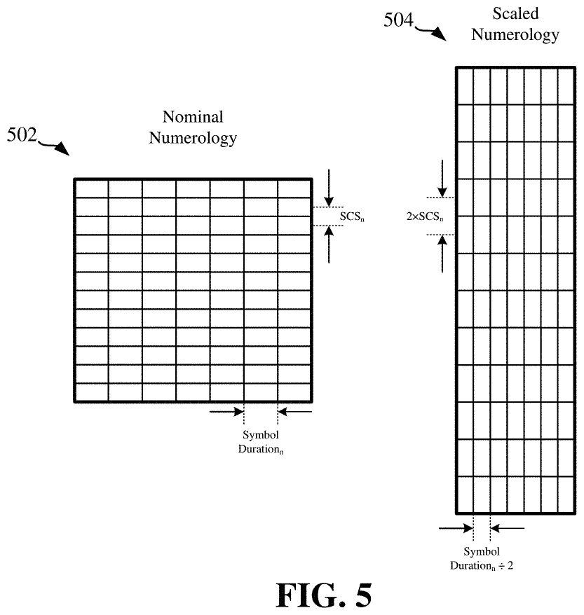

To illustrate this concept of a scalable numerology, FIG. 5 shows a first RB 502 having a nominal numerology, and a second RB 504 having a scaled numerology. As one example, the first RB 502 may have a ‘nominal’ subcarrier spacing (SCSₙ) of 30 kHz, and a ‘nominal’ symbol durationₙ of 333 μs. Here, in the second RB 504, the scaled numerology includes a scaled SCS of double the nominal SCS, or 2×SCSₙ=60 kHz. Because this provides twice the bandwidth per symbol, it results in a shortened symbol duration to carry the same information. Thus, in the second RB 504, the scaled numerology includes a scaled symbol duration of half the nominal symbol duration, or (symbol durationₙ)÷2=167 μs.

### Scheduling Entity

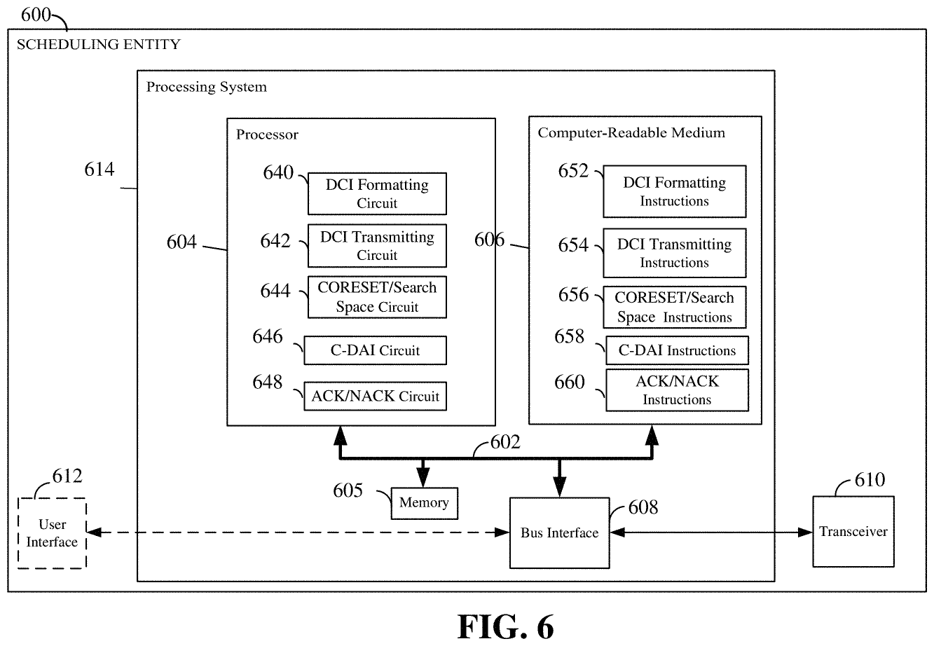

FIG. 6 is a block diagram conceptually illustrating an example of a hardware implementation for a scheduling entity 600 employing a processing system 614 according to some aspects of the disclosure. For example, the scheduling entity 600 may be a user equipment (UE) as illustrated in any one or more of FIGS. 1, 2, and/or 3. In another example, the scheduling entity 600 may be a base station as illustrated in any one or more of FIGS. 1, 2, and/or 3.

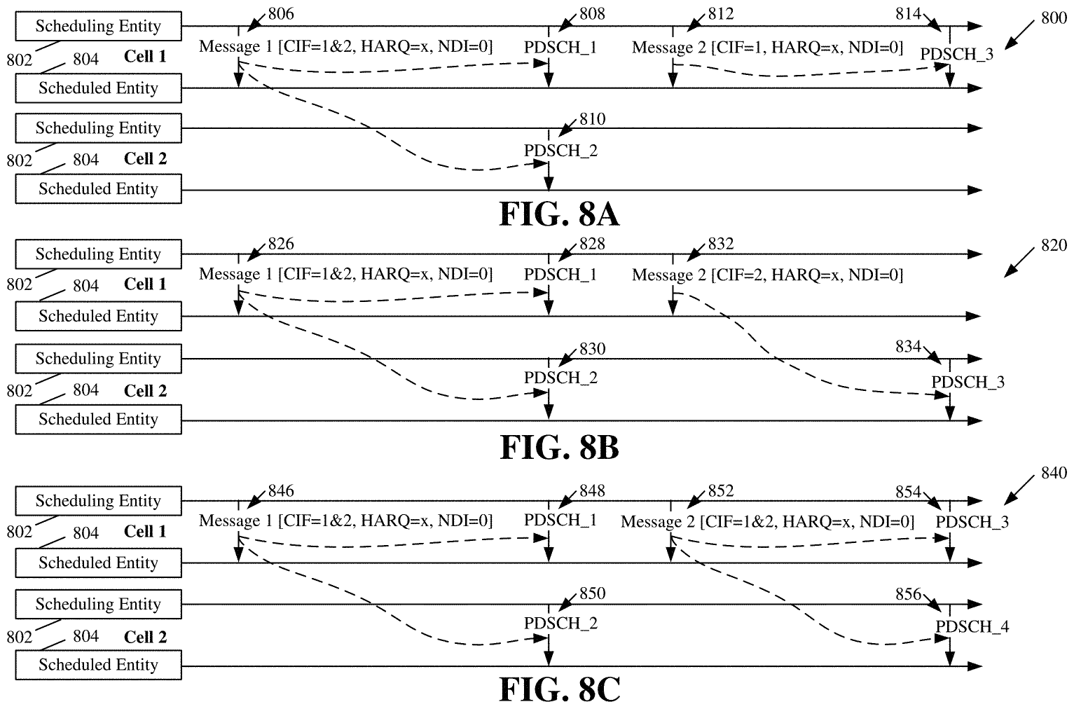

The scheduling entity 600 may be implemented with a processing system 614 that includes one or more processors 604. Examples of processors 604 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 600 may be configured to perform any one or more of the functions described herein. That is, the processor 604, as utilized in a scheduling entity 600, may be used to implement any one or more of the processes and procedures described below and illustrated in FIGS. 8-12.

In this example, the processing system 614 may be implemented with a bus architecture, represented generally by the bus 602. The bus 602 may include any number of interconnecting buses and bridges depending on the specific application of the processing system 614 and the overall design constraints. The bus 602 communicatively couples together various circuits including one or more processors (represented generally by the processor 604), a memory 605, and computer-readable media (represented generally by the computer-readable medium 606). The bus 602 may also link various other circuits such as timing sources, peripherals, voltage regulators, and power management circuits, which are well known in the art, and therefore, will not be described any further. A bus interface 608 provides an interface between the bus 602 and a transceiver 610. The transceiver 610 provides a communication interface or means for communicating with various other apparatus over a transmission medium. Depending upon the nature of the apparatus, a user interface 612 (e.g., keypad, display, speaker, microphone, joystick) may also be provided. Of course, such a user interface 612 is optional, and may be omitted in some examples, such as a base station.

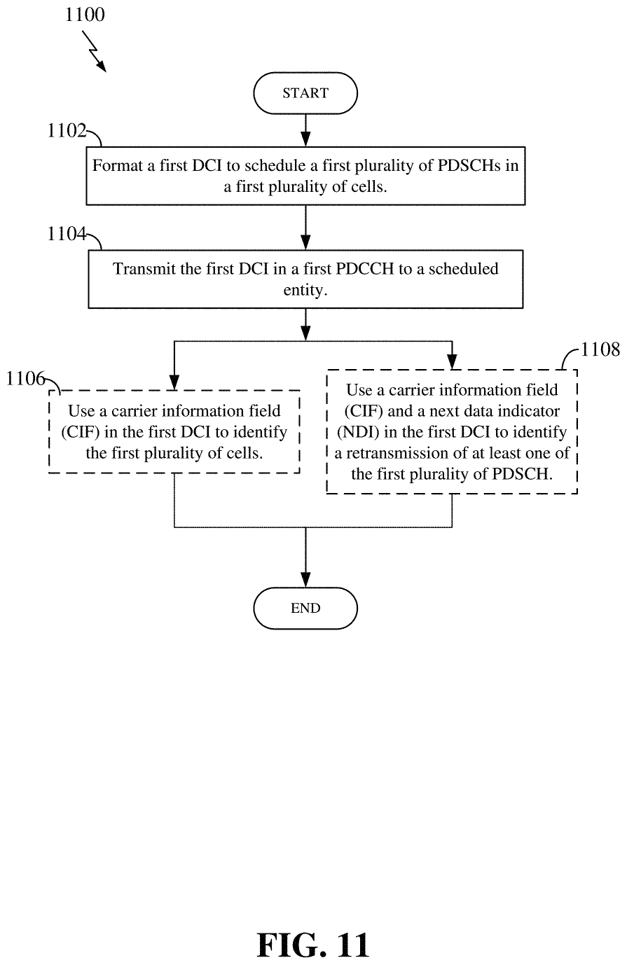

In some aspects of the disclosure, the processor 604 may include DCI formatting circuitry 640 configured for various functions, including, for example, formatting a first DCI to schedule a first plurality of PDSCHs in a first plurality of cells. The processor 604 may further include, for example, DCI transmitting circuitry 642 configured for various functions, including, for example, transmitting the first DCI in a first PDCCH to a scheduled entity. The processor 604 may further include, for example, CORESET/search space circuitry 644 configured for various functions, including, for example, configuring a set of CCEs to DCIs with CIF field indications for each cell (e.g., component carrier, {cell A}, {cell B}, {cell A, B}, etc.) The processor 604 may further include, for example, C-DAI circuitry 646 configured for various functions, including, for example, setting and incrementing a C-DAI counter, where, for example, if the C-DAI is increased by 1 per DCI, then at most one DCI can be indicated with CIF={cell A}, {cell B}, and {cell A, B} per PDCCH occasion per cell. The processor 604 may further include, for example, ACK/NACK bundling circuitry 648 configured for various functions, including, for example, applying ACK/NACK bundling to multiple PDSCHs scheduled by the same DCI. For example, DCI formatting circuitry 640, CIF field circuitry 642, coreset/search space circuitry 644, C-DAI circuitry 646, ACK/NACK bundling circuitry 648 may be configured to implement one or more of the functions described below in relation to FIGS. 8-12, including, e.g., block 1102 of FIG. 11.

The processor 604 is responsible for managing the bus 602 and general processing, including the execution of software stored on the computer-readable medium 606. The software, when executed by the processor 604, causes the processing system 614 to perform the various functions described below for any particular apparatus. The computer-readable medium 606 and the memory 605 may also be used for storing data that is manipulated by the processor 604 when executing software.

One or more processors 604 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 606. The computer-readable medium 606 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 606 may reside in the processing system 614, external to the processing system 614, or distributed across multiple entities including the processing system 614. The computer-readable medium 606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 606 may include, for example, DCI formatting instructions 652 (e.g., software) configured for various functions, including, for example, formatting a first DCI to schedule a first plurality of PDSCHs in a first plurality of cells. The computer-readable storage medium 606 may further include, for example, DCI transmitting instructions 654 (e.g., software) configured for various functions, including, for example, transmitting the first DCI in a first PDCCH to a scheduled entity. The computer-readable storage medium 606 may further include, for example, coreset or search space instructions 656 (e.g., software) configured for various functions, including, for example, configuring a set of CCEs to DCIs with CIF field indications for each cell. The computer-readable storage medium 606 may further include, for example, C-DAI instructions 658 (e.g., software) configured for various functions, including, for example, setting and incrementing a C-DAI counter. The computer-readable storage medium 606 may further include, for example, ACK/NACK bundling instructions 660 (e.g., software) configured for various functions, including, for example, applying ACK/NACK bundling to multiple PDSCHs scheduled by the same DCI. The same and/or additional instructions (e.g., software) may be configured to implement one or more of the functions described below in relation to FIGS. 8-12, including, e.g., block 1102 of FIG. 11.

### Scheduled Entity

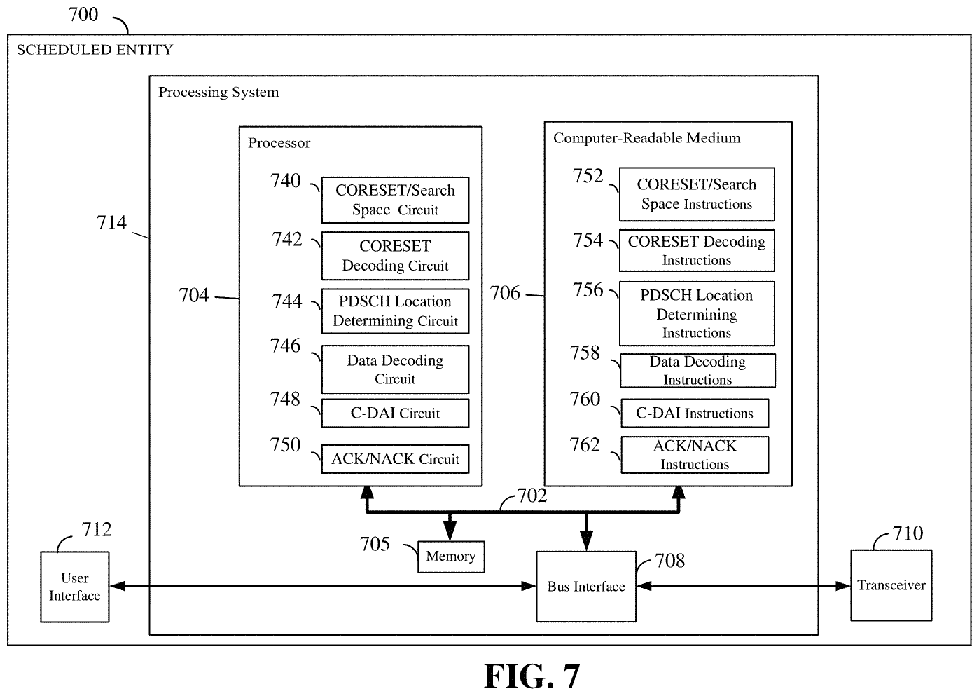

FIG. 7 is a block diagram conceptually illustrating an example of a hardware implementation for a scheduled entity 700 employing a processing system 714. In accordance with various aspects of the disclosure, an element, or any portion of an element, or any combination of elements may be implemented with a processing system 714 that includes one or more processors 704. For example, the scheduled entity 700 may be a user equipment (UE) as illustrated in any one or more of FIGS. 1, 2, and/or 3.

The processing system 714 may be substantially the same as the processing system 614 illustrated in FIG. 6, including a bus interface 708, a bus 702, memory 705, a processor 704, and a computer-readable medium 706. Furthermore, the scheduled entity 700 may include a user interface 712 and a transceiver 710 substantially similar to those described above in FIG. 6. That is, the processor 704, as utilized in a scheduled entity 700, may be used to implement any one or more of the processes described below and illustrated in the drawings appended hereto.

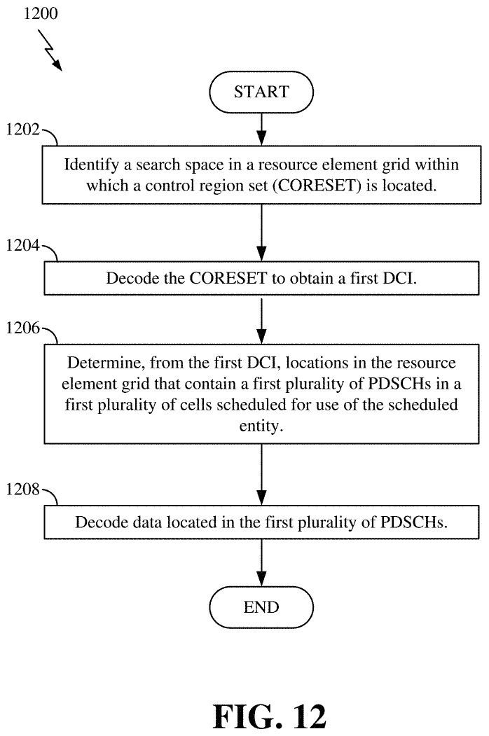

In some aspects of the disclosure, the processor 704 may include, for example, CORESET/search space circuitry 740 configured for various functions, including, for example, identifying a search space in a resource element grid within which a control region set (CORESET) is located and/or configuring a set of CCEs to DCIs with CIF field indications for each cell (e.g., component carrier, {cell A}, {cell B}, {cell A, B}, etc.). The processor 704 may further include, for example, CORESET decoding circuitry 742 configured for various functions, including, for example, decoding the CORESET to obtain a first DCI. The processor 704 may further include, for example, PDSCH location determining circuitry 744 configured for various functions, including, for example, determining, from the first DCI, locations in the resource element grid that contain a first plurality of PDSCHs in a first plurality of cells scheduled for use of the scheduled entity. The processor 704 may further include, for example, data decoding circuitry 746, configured for various functions, including, for example, decoding data located in the first plurality of PDSCHs. The processor 704 may still further include, for example, C-DAI circuitry 748 configured for various functions, including, for example, setting and incrementing a C-DAI counter, where, for example, if the C-DAI is increased by 1 per DCI, then at most one DCI can be indicated with CIF={cell A}, {cell B}, and {cell A, B} per PDCCH occasion per cell. The processor 704 may further include, for example, ACK/NACK bundling circuitry 750 configured for various functions, including, for example, applying ACK/NACK bundling to multiple PDSCHs scheduled by the same DCI. For example, CORESET and/or search space circuitry 740, CORESET decoding circuitry 742, PDSCH location determining circuitry 744, data decoding circuitry 746, C-DAI circuitry 748, ACK/NACK bundling circuitry 750 may be configured to implement one or more of the functions described below in relation to FIGS. 8-12, including, e.g., block 1202 of FIG. 12.

In one or more examples, the computer-readable storage medium 706 may include, CORESET and/or search space instructions 752 (e.g., software) configured for various functions, including, for example, identifying a search space in a resource element grid within which a control region set (CORESET) is located and/or configuring a set of CCEs to DCIs with CIF field indications for each cell (e.g., component carrier, {cell A}, {cell B}, {cell A, B}, etc.). The computer-readable storage medium 706 may further include, for example, CORESET decoding instructions 754 (e.g., software) configured for various functions, including, for example, decoding the CORESET to obtain a first DCI. The computer-readable storage medium 706 may further include, for example, PDSCH location determining instructions 756 (e.g., software) configured for various functions, including, for example, determining, from the first DCI, locations in the resource element grid that contain a first plurality of PDSCHs in a first plurality of cells scheduled for use of the scheduled entity. The computer-readable storage medium 706 may further include, for example, data decoding instructions (e.g., software) 758, configured for various functions, including, for example, decoding data located in the first plurality of PDSCHs. The computer-readable storage medium 706 may further include, for example, C-DAI instructions 760 (e.g., software) configured for various functions, including, for example, setting and incrementing a C-DAI counter. The computer-readable storage medium 706 may further include, for example, ACK/NACK bundling instructions 762 (e.g., software) configured for various functions, including, for example, applying ACK/NACK bundling to multiple PDSCHs scheduled by the same DCI. The same and/or additional instructions (e.g., software) may be configured to implement one or more of the functions described in relation to FIGS. 8-12, including, e.g., block 1202 of FIG. 12.

FIG. 8A is a call flow diagram depicting an exchange of messages between a scheduling entity 802 and a scheduled entity 804 and a scheduling of a plurality of physical downlink shared channels (PDSCHs) on a plurality of cells (e.g., carriers, component carriers) according to some aspects of the disclosure. FIG. 8A graphically depicts one aspect of a transmission scheduling and retransmission scheme that may be implemented in networks that are adapted to use a single DCI to schedule the plurality of PDSCHs on the plurality of cells according to some aspects of the disclosure. A first frequency vs. time chart 800 is presented, where frequency is represented on a vertical axis and time is represented on a horizontal axis.

The scheduling entity 802 may transmit a first message 806 (Message 1) to the scheduled entity 804. The first message 806 may be in a form of a downlink control information (DCI); that is a single DCI. The first message may be transmitted on a physical downlink control channel (PDCCH). The first message 806 may include, for example, a carrier information field (CIF) value, a HARQ process identifier value, and a new data indicator (NDI) value. The CIF value may be configured to identify sets of cells (e.g., {Cell 1} (a set of one cell), {Cell 2} (another set of one cell), {Cell 1 & 2} (a set of two cells)). Additional sets of two or more cells are within the scope of the disclosure.

In the example of FIG. 8A, the CIF value is “1&2”, which is indicative of a command given in the first message 806 (e.g., a single DCI) to schedule the plurality of PDCCHs (e.g., PDSCH_1 808 and PDSCH_2 810) on the plurality of cells (e.g., Cell 1 and Cell 2). The scheduling of the plurality of PDSCHs according to the first message (e.g., a single DCI) is represented by the dashed line arrows emanating from the first message (or emanating from a PDCCH transporting the first message 806) and terminating at PDSCH_1 808 and PDSCH_2 810.

Following reception of the first message 806, and the scheduling of the plurality of PDSCHs (PDSCH_1 808 and PDSCH_2 810) on the plurality of cells (Cell 1 and Cell 2), the scheduling entity 802 may transmit a second message 812 (Message 2) to the scheduled entity 804. The second message 812 may also be in the form of a downlink control information (DCI); that is a second single DCI. As before, the first message 806 may be transmitted on a physical downlink control channel (PDCCH). The second message 812 may also include, for example, a carrier information field (CIF) value, a HARQ process identifier value, and a new data indicator (NDI) value.

In the example of FIG. 8A, the CIF value is changed to “1” and is indicative of a command given in the second message 812 (e.g., the second single DCI) to schedule one PDSCH (e.g., PDSCH_3 814 on one cell (e.g., Cell 1). The scheduling of the one PDSCH (PDSCH_3 814) by the second message (e.g., the second single DCI) is represented by the dashed line arrow emanating from the second message 812 (or emanating from a PDCCH transporting the second message 812) and terminating at PDSCH_3 814.

Accordingly, a first portion of the transmission scheme may be expressed by noting that if the CIF value is representative of any given set of cells (e.g., {Cell 1}, {Cell 2}, {Cells 1&2}, then the message carrying the CIF (or some other field that can be configured to identify sets of cells) indicates that the message reflects the scheduling of the set of cells on a corresponding number of PDSCHs. Additionally, if the if the NDI in the second message (e.g., the second single DCI) is not toggled relative to the first message (e.g., relative to the first single DCI), then the second message 812 (the DCI) indicates that a PDSCH of the same HARQ ID previously transmitted on the given cell is to be retransmitted.

The exercise with respect to FIG. 8A may be repeated with respect to FIG. 8B. Accordingly, turning to FIG. 8B, FIG. 8B also graphically depicts the one aspect of the transmission scheduling and retransmission scheme that may be implemented in networks that are adapted to use a single DCI to schedule the plurality of PDSCHs on the plurality of cells according to some aspects of the disclosure. In FIG. 8B, a second frequency vs. time chart 820 is presented.

The scheduling entity 802 may transmit a first message 826 (Message 1) to the scheduled entity 804. The first message 826 may be in a form of a downlink control information (DCI); that is a single DCI. The first message 826 may be transmitted on a physical downlink control channel (PDCCH). The first message 826 may include, for example, a carrier information field (CIF) value, a HARQ ID value, and a new data indicator (NDI) value. As before the CIF value may be configured to identify sets of cells.

In the example of FIG. 8B, the CIF value is “1&2”, which is indicative of a command given in the first message 826 (e.g., a single DCI) to schedule the plurality of PDSCHs (e.g., PDSCH_1 828 and PDSCH_2 830) on the plurality of cells (e.g., Cell 1 and Cell 2). The scheduling of the plurality of PDSCHs according to the first message 826 is represented by the dashed line arrows emanating from the first message 826 (or emanating from a PDCCH transporting the first message 826) and terminating at PDSCH_1 828 and PDSCH_2 830.

Following reception of the first message 826, and the scheduling of the plurality of PDSCHs (PDSCH_1 828 and PDSCH_2 830) on the plurality of cells (Cell 1 and Cell 2), the scheduling entity 802 may transmit a second message 832 (Message 2) to the scheduled entity 804. The second message 832 may also include, for example, a carrier information field (CIF) value, a HARQ ID value, and a new data indicator (NDI) value.

In the example of FIG. 8B, the CIF value is changed to “2” and is indicative of a command given in the second message 832 to schedule one PDCCH (e.g., PDSCH_3 834 on one cell (e.g., Cell 2). The scheduling of the one PDSCH (PDSCH_3 834) by the second message 812 is represented by the dashed line arrow emanating from the second message 832 (or emanating from a PDCCH transporting the second message 832) and terminating at PDSCH_3 834.

Accordingly, the first portion of the transmission scheme may be restated by again noting that if the CIF value is representative of any given set of cells (e.g., {Cell 1}, {Cell 2}, {Cells 1&2}, then the message carrying the CIF (or some other field that can be configured to identify sets of cells) indicates that the message reflects the scheduling of the set of cells on a corresponding number of PDSCHs. Additionally, if the if the NDI in the second message 832 is not toggled relative to the first message 826, then the second message indicates that a PDSCH of the same HARQ ID previously transmitted on the given cell is to be retransmitted.

The exercise with respect to FIGS. 8A and 8B may again be repeated with respect to FIG. 8C. Accordingly, turning to FIG. 8C, FIG. 8C also graphically depicts the one aspect of the transmission scheduling and retransmission scheme that may be implemented in networks that are adapted to use a single DCI to schedule the plurality of PDSCHs on the plurality of cells according to some aspects of the disclosure. In FIG. 8C, a third frequency vs. time chart 840 is presented.

The scheduling entity 802 may transmit a first message 846 (Message 1) to the scheduled entity 804. The first message 846 may be in a form of a downlink control information (DCI); that is a single DCI. The first message 846 may be transmitted on a physical downlink control channel (PDCCH). The first message 846 may include, for example, a carrier information field (CIF) value, a HARQ ID value, and a new data indicator (NDI) value. As before the CIF value may be configured to identify sets of cells.

In the example of FIG. 8C, the CIF value is “1&2”, which is indicative of a command given in the first message 826 (e.g., a single DCI) to schedule the plurality of PDSCHs (e.g., PDSCH_1 828 and PDSCH_2 830) on the plurality of cells (e.g., Cell 1 and Cell 2). The scheduling of the plurality of PDSCHs according to the first message 846 is represented by the dashed line arrows emanating from the first message 846 (or emanating from a PDCCH transporting the first message 846) and terminating at PDSCH_1 848 and PDSCH_2 850.

Following reception of the first message 846, and the scheduling of the plurality of PDSCHs (PDSCH_1 848 and PDSCH_2 850) on the plurality of cells (Cell 1 and Cell 2), the scheduling entity 802 may transmit a second message 852 (Message 2) to the scheduled entity 804. The second message 852 may also include, for example, a carrier information field (CIF) value, a HARQ ID value, and a new data indicator (NDI) value.

In the example of FIG. 8C, the CIF value is remains “1&2” and is indicative of a command given in the second message 852 to schedule two PDCCHs (e.g., PDSCH_3 854 and PDSCH_4 856) on tow cells (e.g., Cell 1 and Cell 2). The scheduling of the two PDSCHs (PDSCH_3 854 and PDSCH_4 856) by the second message 852 is represented by the dashed line arrows emanating from the second message 852 (or emanating from a PDCCH transporting the second message 852) and terminating at PDSCH_3 854 and PDSCH_4 856.

Accordingly, the first portion of the transmission scheme may be restated by again noting that if the CIF value is representative of any given set of cells (e.g., {Cell 1}, {Cell 2}, {Cells 1&2}, then the message carrying the CIF (or some other field that can be configured to identify sets of cells) indicates that the message reflects the scheduling of the set of cells on a corresponding number of PDSCHs. Additionally, if the if the NDI in the second message 832 is not toggled relative to the first message 846, then the second message 852 indicates that a PDSCH of the same HARQ ID previously transmitted on the given cell is to be retransmitted.

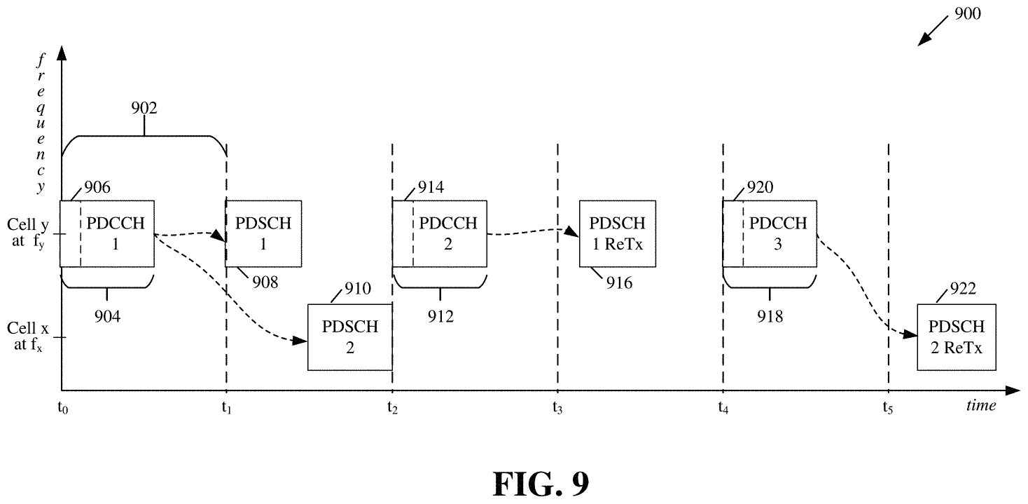

FIG. 9 is a block diagram illustrating a scheduling of physical downlink shared channels (PDSCHs) and retransmission of PDCCHs that were associated with negative acknowledgements (NACKs) according to some aspects of the disclosure. A frequency versus time chart 900 is presented in FIG. 9. Frequency is depicted on the vertical axis and time is depicted on the horizontal axis. A control resource set (CORESET) may be associated with a first search space 906. The first search space 906 may be located associated with the first PDCCH_1 904. The CORESET/search space is a set of physical resources and a set of parameters that is used for PDCCH/DCI monitoring. The search space may include a set of CCEs that can be configured to monitor PDCCHs/DCIs with CIF adapted to indicate sets of sells ({Cell y}, {Cell x} {Cells x&y}). According to the illustration of FIG. 9, the first search space 906 (defined in frequency and time) may be associated with the first PDCCH_1 904. The first PDCCH 904 may be located in a PDCCH monitoring occasion within a first interval of time (e.g., a slot or mini-slot) depicted as starting at time=t0, predetermined by the search space 906 and the associated CORESET. A DCI with CIF field may be detected from the CORESET in the first search space 906. As previously described, a single DCI may be used to schedule a plurality of PDSCHs (e.g., PDSCH_1 908 and PDSCH_2 910) as depicted by the dashed arrows emanating from the first PDCCH_1 904 and terminating at PDSCH_1 908 and PDSCH_2 910. The plurality of PDSCHs in the second dime interval t1-t2 may be scheduled by the DCI in the first PDCCH_1 904 in first time interval t0-t1.

A new search space 914 may be established in the third time interval t2-t3. A CORESET and the search space 914 of the PDCCH_2 912 may include a second PDCCH monitoring occasion for a second single DCI. Utilizing the CIF value, HARQ ID, and NDI as described in FIGS. 8A, 8B, and 8C, the second single DCI may serve to schedule a plurality of PDSCHs in the fourth time interval t4-t3. In the illustration of FIG. 9, however, the use of the DCI of PDSCCH_2 912, and the CIF, HARQ IQ, and NDI fields, one PDSCH 916 is scheduled for the fourth time interval t4-t3. Again, using the CIF, HARQ IQ, and NDI fields associated with the second single DCI, the one PDSCH 916 scheduled for the fourth time interval t4-t3 is a retransmission of PDSCH_1 908 from the second time interval t2-t1.

Still another new search space 920 may be established in the fifth time interval t5-t4. A CORESET and the search space 920 of the PDCCH_3 918 may include a third PDCCH monitoring occasion for a third single DCI. Utilizing the CIF value, HARQ ID, and NDI as described in FIGS. 8A, 8B, and 8C, the third single DCI may serve to schedule a plurality of PDSCHs in the sixth time interval t6-t5. In the illustration of FIG. 9, however, the use of the DCI of PDSCH_3 918, and the CIF, HARQ IQ, and NDI fields, one PDSCH 922 is scheduled for the sixth time interval t6-t5. Again, using the CIF, HARQ IQ, and NDI fields associated with the third single DCI, the one PDSCH 922 scheduled for the sixth time interval t6-t5 is a retransmission of PDSCH_2 910 from the second time interval t2-t1. The search space 906, 914, 920 can have the same search space ID, and can also associated with the same CORESET ID. The PDCCH_1 904, PDCCH_2 912, PDCCH_3 918 can be detected on the same set of CCEs on the search space. As another example, the scheduled entity 1004 can be configured with the same PDCCH candidate with the same CCE aggregation level in the same CORESET for the same DCI format of the same payload associated with cell 1, cell 2, and cell 1 and 2, and can receive a corresponding PDCCH through the PDCCH candidate that schedules for cell 1, cell 2, or cell 1 and 2. It is noted that at most one DCI may be indicated with CIF={cell A}, {cell B}, and {cell A, B} per PDCCH occasion per cell.

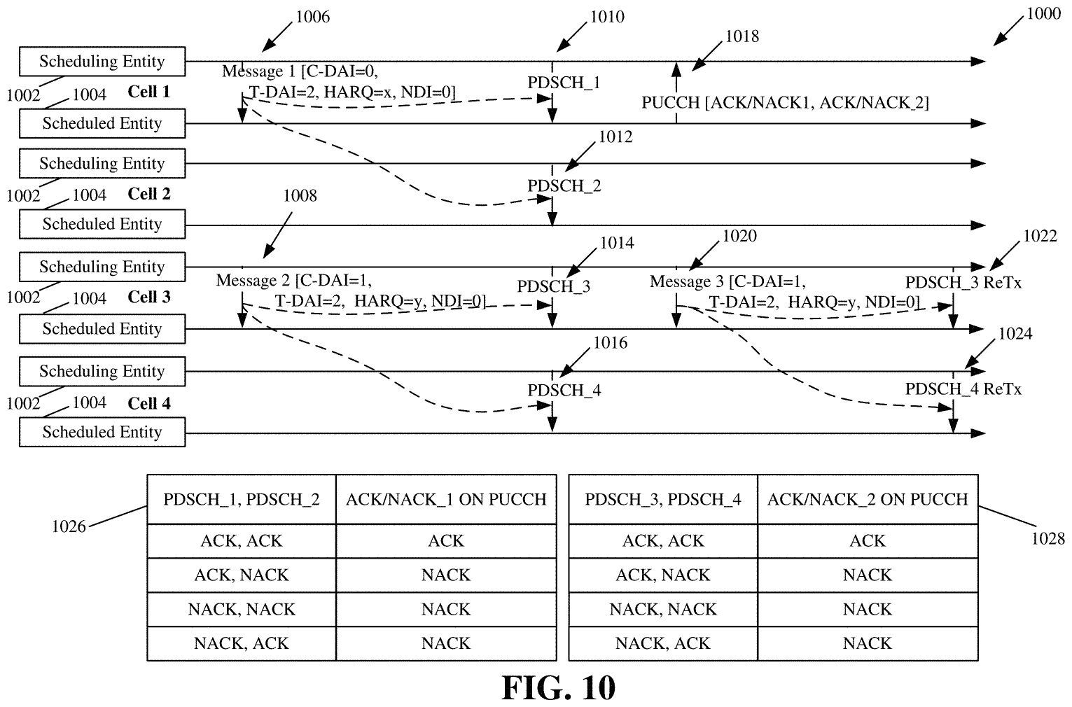

FIG. 10 is a call flow diagram depicting an exchange of messages between a scheduling entity 1002 and a scheduled entity 1004 and a truth table for determining conditions under which scheduled downlink channels (PDSCH are retransmitted according to some aspects of the disclosure. A frequency versus time chart 1000 is presented in FIG, 10, Frequency is depicted on the vertical axis and time is depicted on the horizontal axis.

The scheduling entity 1002 may transmit a first message 1006 (Message 1) to the scheduled entity 804. The first message 1006 may be in a form of a downlink control information (DCI); that is a single DCI. The first message may be transmitted on a physical downlink control channel (PDCCH). The first message 806 may include, for example, a field representing a total size of a HARQ-ACK payload (that is, total-downlink assignment indicator or T-DAI, a counter-DAI (C-DAI), a HARQ process identifier value or HARQ Index value, and a new data indicator (NDI) value. If the C-DAI is increased by 1 per DCI, and at most one DCI can be indicated with CIF={Cell 1}, {Cell 2}, and {Cell 1, 2} per PDCCH occasion per cell, the number of ACK/NACK bits in PUCCH for a given cell should be based on maximum number of possible scheduled multiple PDSCHs on the PDCCH monitoring occasion. That is, for example, the use of a single DCI to schedule a plurality of PDSCHs on a plurality of cells. For example, for CIF={Cell 1}, {Cell 2}, and {Cell 1, 2} per PDCCH occasion per cell, the maximum number of possible scheduled PDSCHs is 2, and there can be two ACK/NACK bits in PUCCH for the PDCCH monitoring occasion on the cell. Therefore, the scheduled entity 1004 finds that there is a DCI lost on the cell based on the DAI mechanism, two NACK bits will be set in the corresponding positions of PUCCH for indicating the lost DCI.

In the example of FIG. 10, in Message 1 1006 (e.g., a first single DCI), the contents of the message indicate that C-DAI=0, T-DAI=2, HARQ=x, and NDI=0. This message informs the scheduled entity that PDSCH_1 1010 is scheduled for Cell 1 and PDSCH_2 1012 is scheduled for Cell 2. In Message 2 1008 (e.g., a second single DCI), the contents of the message indicate that C-DAI=1, T-DAI=2, HARQ=y, and NDI=0. This configuration informs the scheduled entity that PDSCH_3 1014 is scheduled for Cell 3 and PDSCH_4 1016 is scheduled for Cell 4.

Referring to PUCCH 1018 and table 1026, one ACK/NACK bit may be included in PUCCH 1018 for Message 1 1006. The ACK/NACK bit=1 if both ACK/NAK for PDSCH_1 1010 and PDSCH_2 1012 are ACK. The ACK/NACK bit=0 if either ACK/NAK for PDSCH_1 1010 or PDSCH_2 1012 are NACK. Similarly, referring to PUCCH 1018 and table 1028, one ACK/NACK bit may be included in PUCCH 1018 for Message 2 1008. The ACK/NACK bit=1 if both ACK/NAK for PDSCH_3 1014 and PDSCH_4 1016 are ACK. The ACK/NACK bit=0 if either ACK/NAK for PDSCH_3 1014 or PDSCH_4 1016 are NACK.

Returning to the frequency versus time chart 1000, the scheduling of the plurality of PDSCHs (PDSCH_1 101, and PDCH_2 1012) according to the first message 1006 (e.g., a single DCI) is represented by the dashed line arrows emanating from the first message 1006 (or emanating from a PDCCH transporting the first message 1006) and terminating at PDSCH_1 1008 and PDSCH_2 1010. In this example, the ACK/NACK bit would be set to 1 in PUCCH 1018 for ACK/NACK_1. However, the ACK/NACK bit would be set to 0 in PUCCH 1018 for ACK/NACK_2. Accordingly, in Message 3 1020, C-DAI=1, T-DAI=2, HARQ=x, and NDI=0. At least because NDI has not toggled between the value in the Message 2 1008 and Message 3 1020, PDSCH_3 (from 1014) is retransmitted as PDSCH_3 ReTx 1022 and PDSCH_4 (from 1016) is retransmitted as PDSCH_4 ReTx 1024.

FIG. 11 is a flow chart illustrating an exemplary process 1100 for wireless communication operational at a scheduling entity in accordance with some aspects of the present disclosure. The process 1100 may be used to implement dynamic spectrum sharing. As described below, some or all illustrated features may be omitted in a particular implementation within the scope of the present disclosure, and some illustrated features may not be required for implementation of all embodiments. In some examples, the process 1100 may be carried out by the scheduling entity 600 illustrated in FIG. 6. In some examples, the process 1100 may be carried out by any suitable apparatus or means for carrying out the functions or algorithm described below.

At block 1102, the scheduling entity 700 may format a first DCI to schedule a first plurality of PDSCHs in a first plurality of cells. At block 1104, the scheduling entity may transmit the first DCI in a first PDCCH to a scheduled entity. At block 1106, the scheduling entity may optionally use a carrier information field (CIF) in the first DCI to identify the first plurality of cells. Alternatively, at block 1008, the scheduling entity may optionally use a carrier information field (CIF) and a new data indicator (NDI) in the first DCI to identify a retransmission of at least one of the first plurality of PDSCH.

FIG. 12 is a flow chart illustrating an exemplary process 1200 for wireless communication operational at a scheduling entity according to some aspects of the present disclosure. The process 1200 may be used to implement dynamic spectrum sharing. As described below, some or all illustrated features may be omitted in a particular implementation within the scope of the present disclosure, and some illustrated features may not be required for implementation of all embodiments. In some examples, the process 1200 may be carried out by the scheduled entity 700 illustrated in FIG. 7. In some examples, the process 1100 may be carried out by any suitable apparatus or means for carrying out the functions or algorithm described below.

At block 1202, the scheduled entity may identify a search space in a resource element grid within which a control region set (CORESET) is located. At block 1204, the scheduled entity may decode the CORESET to obtain a first DCI. At block 1206, the scheduled entity may determine, from the first DCI, locations in the resource element grid that contain a first plurality of PDSCHs in a first plurality of cells scheduled for use of the scheduled entity. At block 1206, the scheduled entity may decode data located in the first plurality of PDSCHs.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-10 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-10 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication, operational at a scheduling entity, comprising:
formatting a first downlink control information (DCI) to schedule a first plurality of physical downlink shared channels (PDSCHs) in a first plurality of cells; and
transmitting the first DCI in a first physical downlink control channel (PDCCH) to a scheduled entity.

2. The method of claim 1, wherein there is a one-to-one relationship between the first plurality of PDSCHs and the first plurality of cells.

3. The method of claim 1, wherein there is a many-to-one relationship between the first plurality of PDSCHs and the first plurality of cells, respectively.

4. The method of claim 1, further comprising using a carrier information field (CIF) in the first DCI to identify the first plurality of cells.

5. The method of claim 4, wherein the CIF identifies a subset of the first plurality of cells.

6. The method of claim 1, further comprising using a carrier information field (CIF) and a new data indicator (NDI) in the first DCI to identify a retransmission of at least one of the first plurality of PDSCH.

7. The method of claim 6, wherein the CIF identifies the at least one of the first plurality of PDSCH and the NDI indicates that the at least one of the first plurality of PDSCH is a retransmission if an immediately preceding NDI in an immediately preceding DCI is equal to the NDI in the first DCI.

8. The method of claim 6, further comprising using a HARQ process identifier to identify content of the at least one of the PDSCHs.

9. The method of claim 1, further comprising:
receiving in a single PUCCH an acknowledgement/negative acknowledgement (ACK/NACK) relevant to the first DCI;
formatting a second DCI to schedule a retransmission of the first plurality of PDSCHs if the ACK/NACK is a NACK; and
transmitting the second DCI in a second PDCCH to the scheduled entity.

10. The method of claim 1, further comprising:
receiving in a single PUCCH an acknowledgement/negative acknowledgement (ACK/NACK) relevant to a plurality of DCIs;
formatting a second DCI to schedule a retransmission of any set of PDSCHs associated with a NACK; and
transmitting the second DCI in a second PDCCH, different from the first PDCCH, to the scheduled entity.

11. The method of claim 1, further comprising:
formatting a second DCI to schedule a second plurality of PDSCHs in a second plurality of cells;
transmitting the second DCI in a second PDCCH, different from the first PDCCH, to a scheduled entity; and
receiving in a single PUCCH an acknowledgement/negative acknowledgement (ACK/NACK) relevant to both the first DCI and the second DCI.

12. The method of claim 11, further comprising:
formatting a third DCI, in response to receiving a NACK in the single PUCCH, to re-schedule at least one of the first plurality of PDSCHs or the second plurality of PDSCHs, based on content of the NACK; and
transmitting the third DCI in a third PDCCH to the scheduled entity.

13. An apparatus for wireless communication, comprising:
means for formatting a first downlink control information (DCI) to schedule a first plurality of physical downlink shared channels (PDSCHs) in a first plurality of cells; and
means for transmitting the first DCI in a first physical downlink control channel (PDCCH) to a scheduled entity.

14. A non-transitory computer-readable medium storing computer-executable code, comprising code for causing a computer to:
format a first downlink control information (DCI) to schedule a first plurality of physical downlink shared channels (PDSCHs) in a first plurality of cells; and
transmit the first DCI in a first physical downlink control channel (PDCCH) to a scheduled entity.

15. An apparatus for wireless communication, comprising:
a processor;
a transceiver communicatively coupled to the processor; and
a memory communicatively coupled to the processor, wherein the processor is configured to:
format a first downlink control information (DCI) to schedule a first plurality of physical downlink shared channels (PDSCHs) in a first plurality of cells; and
transmit the first DCI in a first physical downlink control channel (PDCCH) to a scheduled entity.

16. A method of wireless communication, operational at a scheduled entity, comprising:
identifying a search space in a resource element grid within which a control region set (CORESET) is located;
decoding the CORESET to obtain a first downlink control information (DCI);
determining, from the first DCI, locations in the resource element grid that contain a first plurality of physical downlink shared channels (PDSCHs) in a first plurality of cells scheduled for use of the scheduled entity; and
decoding data located in the first plurality of PDSCHs.

17. The method of claim 16, wherein there is a one-to-one relationship between the first plurality of PDSCHs and the first plurality of cells.

18. The method of claim 16, wherein there is a many-to-one relationship between the first plurality of PDSCHs and the first plurality of cells, respectively.

19. The method of claim 16, further comprising using a carrier information field (CIF) in the first DCI to identify the first plurality of cells.

20. The method of claim 19, wherein the CIF identifies a subset of the first plurality of cells.

21. The method of claim 16, further comprising using a carrier information field (CIF) and a new data indicator (NDI) in the first DCI to identify a retransmission of at least one of the first plurality of PDSCH.

22. The method of claim 21, further comprising decoding data located in the at least one of the first plurality of PDSCHs received in the retransmission.

23. The method of claim 21, wherein the CIF identifies the at least one of the PDSCH and the NDI indicates that the at least one of the PDSCH is a retransmission when an NDI in an immediately preceding DCI is equal to the NDI in the first DCI.

24. The method of claim 21, further comprising using a HARQ process identifier to identify content of the at least one of the first plurality of PDSCHs.

25. The method of claim 16, further comprising:
sending in a single PUCCH an acknowledgement/negative acknowledgement (ACK/NACK) relevant to the first DCI; and
receiving a second DCI scheduling a retransmission of the first plurality of PDSCHs if any PDSCH of the first plurality of PDSCHs is associated with a NACK.

26. The method of claim 16, further comprising;
identifying a subsequent search space in a resource element grid within which a subsequent control region set (CORESET) is located;
decoding the subsequent CORESET to obtain a second DCI;
determining, from the second DCI, locations in the resource element grid that contain at least one second PDSCH in at least one second cells scheduled for use of the scheduled entity; and
decoding data located in the second PDSCH.

27. The method of claim 26, further comprising using a carrier information field (CIF) in the second DCI to identify the at least one second cell.

28. The method of claim 16, further comprising using a carrier information field (CIF) and a new data indicator (NDI) in the second DCI to identify a retransmission of the at least one second PDSCH.

29. The method of claim 16, further comprising decoding data located in the at least one of the second PDSCH received in the retransmission.

30. The method of claim 16, wherein the CIF identifies the at least second PDSCH and the NDI indicates that the at least second PDSCH is a retransmission when the NDI in the first DCI is equal to the NDI in the second DCI.

31. The method of claim 16, further comprising using a HARQ process identifier to identify content of the at least second PDSCH.

32. An apparatus for wireless communication, comprising:
means for identifying a search space in a resource element grid within which a control region set (CORESET) is located;
means for decoding the CORESET to obtain a first downlink control information (DCI);
means for determining, from the first DCI, locations in the resource element grid that contain a first plurality of physical downlink shared channels (PDSCHs) in a first plurality of cells scheduled for use of the scheduled entity; and
means for decoding data located in the first plurality of PDSCHs.

33. A non-transitory computer-readable medium storing computer-executable code, comprising code for causing a computer to:
identify a search space in a resource element grid within which a control region set (CORESET) is located;
decode the CORESET to obtain a first downlink control information (DCI);
determine, from the first DCI, locations in the resource element grid that contain a first plurality of physical downlink shared channels (PDSCHs) in a first plurality of cells scheduled for use of the scheduled entity; and
decode data located in the first plurality of PDSCHs.

34. An apparatus for wireless communication, comprising:
a processor;
a transceiver communicatively coupled to the processor; and
a memory communicatively coupled to the processor, wherein the processor is configured to:
identify a search space in a resource element grid within which a control region set (CORESET) is located;
decode the CORESET to obtain a first downlink control information (DCI);
determine, from the first DCI, locations in the resource element grid that contain a first plurality of physical downlink shared channels (PDSCHs) in a first plurality of cells scheduled for use of the scheduled entity; and
decode data located in the first plurality of PDSCHs.
